(19) United States
(12) Patent Application Publication
(10) Pub. No.: US 2025/0340471 A1
(43) Pub. Date: Nov. 6, 2025

(54) SYSTEM AND METHOD FOR POLYFLUORINATED SUBSTANCES (PFAS) REMEDIATION FROM WATER

(71) Applicant: Azolla Biodesign Inc., Sedona, AZ (US)

(72) Inventor: Victor O. Leshyk, Sedona, AZ (US)

(21) Appl. No.: 19/198,570

(22) Filed: May 5, 2025

Related U.S. Application Data
(60) Provisional application No. 63/641,961, filed on May 3, 2024.

(51) Int. Cl. C02F 9/00; C02F 1/28; C02F 1/34; C02F 1/38; C02F 3/32; C02F 101/36

(52) U.S. Cl. CPC C02F 9/00; C02F 1/283; C02F 1/34; C02F 1/385; C02F 3/327; C02F 2101/36

(57) ABSTRACT

The present disclosure is directed to a system and method for remediation of water sources and/or supplies, wherein the remediation involves removing Polyfluorinated Substances (PFAS) from the water and providing clean filtered water therefrom. In preferred embodiments, the systems and methods detailed herein utilize, at least in part, certain biological plants, such as aquatic plants of the genus Azolla, to remove PFAS and other elements from the water.

### CROSS-REFERENCE TO RELATED APPLICATIONS

This application claims the benefit of U.S. Provisional Patent Application No. 63/641,961, filed May 3, 2024, which is hereby incorporated by reference in its entirety.

### TECHNICAL FIELD

The present disclosure is directed to a system and method for remediation of water sources and/or supplies, wherein the remediation involves removing Polyfluorinated Substances (PFAS) from the water and providing clean filtered water therefrom. In preferred embodiments, the systems and methods detailed herein utilize, at least in part, certain biological plants, such as aquatic plants of the genus Azolla, to remove PFAS and other elements from the water.

### BACKGROUND

PFAS are a family of human-made chemicals that have seen widespread use over the last fifty years. The molecular bonds that connect the atoms forming the molecules of the PFAS are very durable, making PFAS resistant to breakdown and earning PFAS the moniker “forever chemicals.” While high temperature incineration can be used to breakdown PFAS in certain circumstances, high temperature heating is energy intensive and can allow for uncombusted PFAS to escape in exhaust that is a waste product of the incineration process. Other options, such as the use of activated charcoal or resin to filter water, are costly and still require disposal or treatment at high temperature.

Therefore, there is a need in the art for systems and methods that can achieve the removal of PFAS from water for lower cost, lower energy use, and higher efficiency. The exemplary disclosed systems and methods are directed to overcoming one or more shortcomings set forth above and/or other deficiencies in existing technology. Advantages of the present invention will be explained and will become obvious to one skilled in the art through the summary of the invention and detailed description that follows.

### SUMMARY OF THE INVENTION

The present disclosure is directed to a system and method for remediation of water sources and/or supplies, wherein the remediation involves removing Polyfluorinated Substances (PFAS) from the water and providing clean filtered water therefrom. In preferred embodiments, the systems and methods detailed herein utilize, at least in part, certain biological plants, such as aquatic plants of the genus Azolla, to remove PFAS and other elements from the water.

According to an embodiment of the present disclosure, system for remediating polyfluorinated substances (PFAS) from water comprising an array of one or more trays that contain a biomass capable of absorbing PFAS from PFAS contaminated water, wherein the array has a first end that receives the PFAS contaminated water and a second end that discharges treated water, a hydrodynamic cavitation treatment area that receives PFAS containing biomass, wherein the PFAS containing biomass is treated with hydrodynamic cavitation causing a breakdown of PFAS on the PFAS containing biomass, a separator that removes residual water from treated biomass, and one or more activated carbon filter modules that receive one or both of the treated water from the second end of the array and the residual water from the separator, wherein the activated carbon filter modules remove residual PFAS from the treated water and the residual water and discharge polished water.

According to an embodiment of the present disclosure, the biomass is as aquatic plant of the genus Azolla.

According to an embodiment of the present disclosure, the system further comprises a carbon dioxide concentration system supplying carbon dioxide to the array.

According to an embodiment of the present disclosure, the system further comprises a cooling system to maintain an optimal temperature for growth of the biomass.

According to an embodiment of the present disclosure, the hydrodynamic cavitation treatment area is connected to the second end of the array to receive PFAS containing biomass.

According to an embodiment of the present disclosure, the hydrodynamic cavitation treatment area includes an agitator to induce the hydrodynamic cavitation.

According to an embodiment of the present disclosure, the separator is a centrifuge or a drainage basket.

According to an embodiment of the present disclosure, the separator is connected to the hydrodynamic cavitation treatment area to receive the treated biomass.

According to an embodiment of the present disclosure, the separator is connected to the array to return residual water to the array upstream of the second end of the array.

According to an embodiment of the present disclosure, the activated carbon modules have an inlet connected to one or both of the second end of the array and the separator.

According to an embodiment of the present disclosure, the activated carbon modules have an outlet connected to one or both of the array and a system outlet.

According to an embodiment of the present disclosure, a method for remediating polyfluorinated substances (PFAS) from water comprising providing an array containing a PFAS absorbing biomass, receiving PFAS contaminated water from a water source, flowing the PFAS contaminated water through the array, discharging treated water from the array, harvesting PFAS containing biomass from the array, applying hydrodynamic cavitation to the PFAS containing biomass to produce treated biomass, wherein the hydrodynamic cavitation causes a breakdown of PFAS on the PFAS containing biomass, and filtering the treated water through activated carbon to remove residual PFAS and produce polished water.

According to an embodiment of the present disclosure, the method further comprises supplying carbon dioxide to the PFAS absorbing biomass.

According to an embodiment of the present disclosure, the method further comprises collecting fluorine generated during the breakdown of the PFAS.

According to an embodiment of the present disclosure, the method further comprises discharging polished water to the array.

According to an embodiment of the present disclosure, the method further comprises discharging polished water to a system outlet.

According to an embodiment of the present disclosure, the method further comprises removing residual water from the treated biomass.

According to an embodiment of the present disclosure, the method further comprises filtering the residual water through activated carbon to remove residual PFAS and produce polished water.

According to an embodiment of the present disclosure, the method further comprises discharging residual water to the array.

According to an embodiment of the present disclosure, the method further comprises producing activated carbon material by converting treated biomass to biochar.

It may be understood that both the foregoing general description and the following detailed description are exemplary and explanatory only and are not restrictive of the invention, as claimed.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a schematic illustration of a configuration for a system for utilizing aquatic plants to remove PFAS from water, in accordance with an embodiment of the present invention.

FIG. 2 is an illustration of an aquatic plant filtering PFAS from water.

FIG. 3 is a process flow diagram of a method of removing PFAS from water, in accordance with an embodiment of the present invention.

### DETAILED DESCRIPTION OF THE INVENTION

According to one embodiment of the present invention, a system for remediation of water sources and/or supplies, wherein the remediation involves removing Polyfluorinated Substances (PFAS) from the water and providing clean filtered water therefrom.

According to preferred embodiments of the present invention, the system employs hydrodynamic cavitation as a novel approach to treat the Azolla biomass containing captured PFAS. Hydrodynamic cavitation generates microbubbles in water that collapse and release energy, heating the surrounding water to high temperatures. This process is capable of breaking the resilient C—F bonds in PFAS molecules, effectively destroying the contaminants without the need for extensive energy consumption. While the detailed description provided herein will refer to Azolla, one of ordinary skill in the art would appreciate that there are numerous biological plants that could be used, including engineered biological plants, and embodiments of the present invention are contemplated for use with any such biological plants.

Azolla plants, known for their rapid growth and ability to thrive in shallow water, serve as an effective “living filter” for the absorption of PFAS from contaminated water sources. Unlike terrestrial plants, Azolla can accumulate significant amounts of biomass in a short period, making it an ideal candidate for large-scale bioremediation projects. Azolla's capability to uptake PFAS without adverse effects, supports its use in continuous, sustainable water treatment cycles.

According to an embodiment of the present invention, the system maximizes the use of Azolla by cultivating the plants in a dense array of stacked, relatively shallow trays within a controlled environment. This setup allows for the efficient interception and absorption of PFAS from PFAS contaminated water, as the PFAS contaminated water enters at the first end of the array and flows through the trays where the PFAS are absorbed and filtered by a PFAS absorbing biomass, such as Azolla. The PFAS contaminated water flowing through the array results in (i) treated water being discharged from the second end of the array and (ii) a PFAS containing biomass that is ready to be harvested for further treatment. The PFAS containing biomass is a product of the PFAS absorbing biomass having filtered and absorbed the PFAS from the PFAS contaminated water. The set up also allows the flexibility to adjust cultivation and harvesting cycles based on the specific PFAS contaminants present. Post-harvest, the Azolla biomass (i.e. the PFAS containing biomass) is treated via hydrodynamic cavitation to release and recover fluorine gas and potentially other valuable byproducts. This process not only ensures the safe disposal of PFAS but also promotes a closed-loop system that may include the recovery of phosphorus and other elements for reuse in Azolla cultivation or other agricultural applications.

According to an embodiment of the present invention, the proposed system offers a sustainable, energy-efficient method for the remediation of PFAS contaminants from water. By leveraging the natural absorption capabilities of Azolla and the innovative use of hydrodynamic cavitation for biomass treatment, this invention provides a scalable solution that can be adapted to various contamination levels and environmental conditions. Furthermore, in certain embodiments involving a closed-loop system, the closed-loop aspect of the system enhances its sustainability, potentially reducing the environmental impact associated with traditional PFAS remediation techniques.

One of the innovative aspects of embodiments of the present invention lies in the strategic use of Azolla cultures within a built environment optimized for PFAS interception. The system comprises a dense array of numerous stacked, shallow trays, specifically designed to maximize Azolla biomass growth within a limited footprint. These trays are continuously flooded with PFAS-contaminated water from a water source that is connected to the first end of the array. The water source may include, but is not limited to, ground or surface water, depending on the contamination scenario at hand. In other embodiments, larger systems may be developed, with increased amounts of Azolla, or other plant-life that is designed or capable of filtering PFAS from water sources may be used. For instance, in urban environments, where large amounts of PFAS need to be filtered from the water, industrial size filtration plants using Azolla, or other appropriate plant-life, may be utilized. One of ordinary skill in the art would appreciate that there are numerous types of system organizations and sizes, as well as plant-life, that may be utilized, and embodiments of the present invention are contemplated for use with any such implementations.

According to certain embodiments of the present invention, the frequency of Azolla harvesting from this system is meticulously calibrated based on the specific PFAS species present in the incoming water. Adjustments may be made to accommodate the varying uptake capabilities of Azolla in relation to different PFAS/PFOA chain lengths and characteristics, and the prevalence of these substances in the water supply. This adaptability ensures the efficient removal of contaminants over a broad spectrum of PFAS compounds.

In certain embodiments, water testing means may be applied in order to determine multiple factors, such as amount of PFAS/PFOA coming into the purification system, and amounts of PFAS/PFOA remaining after filtration. In this regard, the system may be tailored to increase or decrease the amount of Azolla or other plant-life required to filter the water systems to an acceptable level for that system.

In certain embodiments, to sustain the growth and productivity of Azolla, the system may incorporate in-situ cultivation strategies, enhancing growth by supplementing water with phosphorus and providing artificial lighting, or by replenishing filtration trays with Azolla from a “mother culture”. This mother culture is maintained under optimal conditions, including artificial lighting, nutrient supplementation, and enriched CO₂ levels, to ensure a constant supply of healthy Azolla for the remediation process.

According to certain embodiments of the present invention, post-exposure to contaminated water, the Azolla biomass (i.e. the PFAS containing biomass) undergoes a treatment process using hydrodynamic cavitation. This method involves passing a slurry of wet Azolla biomass through a hydrodynamic cavitation treatment area. In some embodiments, the hydrodynamic cavitation treatment area, which may be connected to the array of trays, is a high-throughput and/or high speed agitator designed to induce cavitation, effectively breaking down the PFAS compounds (resulting in a treated biomass) and releasing fluorine gas. The gas can be captured and repurposed for industrial applications, highlighting the system's contribution to circular economy principles.

Depending on the nature of additional contaminants absorbed by the Azolla, such as heavy metals, the post-treatment biomass may be repurposed for phosphorus recovery, supporting further Azolla cultivation onsite. This creates a sustainable, closed-loop production cycle for the Azolla “living filter”. Alternatively, the treated biomass may be utilized as compost, with recovered phosphorus marketed for agricultural use, or further processed to extract other valuable byproducts, such as heavy metals. In cases where repurposing is not viable, the biomass is disposed of in a safe and environmentally friendly manner.

Hydrodynamic cavitation presents a novel and energy-efficient method for treating Azolla biomass laden with PFAS. By generating microbubbles that collapse and release significant energy, this process can break down PFAS molecules at relatively low energy costs compared to traditional heating methods. The ability of hydrodynamic cavitation to destroy PFAS compounds, converting them into less harmful byproducts, represents a critical advancement in remediation technology.

According to an embodiment of the present invention, a separator may be utilized to separate or remove water from the treated biomass. For instance, after the hydrodynamic cavitation process is completed, the resulting treated biomass is wet. Therefore, it may be advantageous to remove the water from the treated biomass. To facilitate the removal of the water, the treated biomass can be processed by a separator, such as a drainage basket or a centrifuge. The residual water separated from the treated biomass may be filtered through the granular activated carbon filter modules (described below) and/or returned to the array. One of ordinary skill in the art would appreciate that there are numerous types of separators that could be utilized with embodiments of the present invention, and embodiments of the present invention are contemplated for use with any appropriate heating or cooling systems.

Azolla's unique growth characteristics make it an ideal candidate for bioremediation. As one of the fastest-growing plants, Azolla can rapidly cover surfaces of contaminated water, effectively absorbing PFAS. Unlike terrestrial plants that show limited PFAS uptake, Azolla can thrive in minimal water depth, producing a dense biomass capable of significant PFAS absorption. This “living filter” approach not only addresses the contamination at its source but also allows for easy harvesting and replacement of the biomass, facilitating continuous remediation cycles. While preferred embodiments of the present invention may rely on Azolla, one of ordinary skill in the art would appreciate that there are numerous other types of biomass that would be capable of performing in the place of Azolla, including genetically modified or engineered biomass.

Preferred embodiments of the proposed system maximize Azolla's PFAS absorption efficiency through a carefully designed array of stacked trays, optimizing the biomass growth within a controlled environment. By adjusting the water quality, nutrient availability, and lighting conditions, the system ensures the rapid cultivation of Azolla, tailored to the specific requirements of PFAS-contaminated water. The harvested Azolla biomass, once treated through hydrodynamic cavitation, enables the recovery of valuable byproducts, including fluorine gas and potentially heavy metals, contributing to a sustainable, closed-loop remediation process.

Embodiments of the invention underscore the importance of sustainability in PFAS remediation efforts. By integrating Azolla cultivation with hydrodynamic cavitation treatment, the system not only removes PFAS from contaminated water but also recycles the treated biomass. Whether repurposed as compost, utilized for phosphorus recovery, or processed for the extraction of other valuable substances, the treated biomass supports a broader environmental management strategy that prioritizes resource recovery and minimal waste generation.

In certain embodiments of the present invention, the system may incorporate one or more granular activated carbon (GAC) filter modules, as shown in the drawings. In some embodiments, a GAC module is in fluid communication with one or more of the trays containing the biomass, which enables the GAC module to receive water (i.e. treated water) from the one or more trays of the array. In some embodiments, a GAC module is in fluid communication with the separator, which enables the GAC module to receive water (i.e. residual water) that has been separated from the treated biomass. This GAC module may be used as a “polishing” step (i.e to produce polished water) to further remove any residual PFAS or other materials that are not (i) captured by the biomass while passing through the array (i.e. any PFAS or other materials in the treated water) or (ii) broken down during the hydrodynamic cavitation step (i.e. any PFAS or other materials in the residual water). The GAC modules are configured with inlets that connect to one, or both of, the array and the separator. The GAC modules are configured with outlets that connect to one, or both of, the array and a system outlet, such as an external water stream that enables treated water and polished water to be removed from the system. Advantageously, azolla, and other bio materials may be converted into GAC, making the entire process self-renewing and bio-friendly. For instance, after the residual water is separated from the treated biomass, the now dry treated biomass can be converted into biochar.

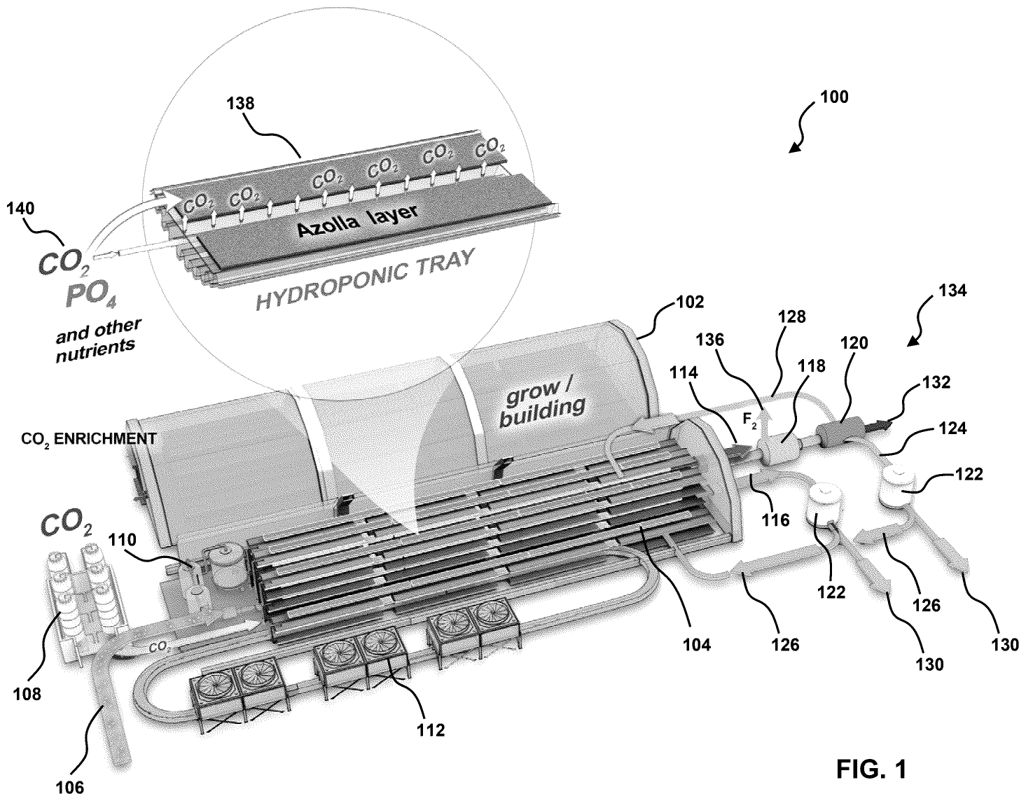

Turning now to FIG. 1, a schematic illustration of a configuration of a PFAS remediation system utilizing aquatic plants to remove PFAS from water, in accordance with an embodiment of the present invention. In a preferred embodiment, the PFAS remediation system 100 may be an entirely or almost entirely enclosed system. In one embodiment, the PFAS remediation system 100 comprises one or more of a grow house 102, a cooling system 112, a CO₂ concentration system 108, and a treatment area 134.

In certain embodiments, the grow house 102 may be comprised of one or more growing areas 104, such as hydroponic trays 138, planters, cultivated growing fields, or any other area suitable for growing a PFAS absorbing biomass (e.g. Azolla). In certain embodiments, various nutrients 140 may be pumped or piped through the growing areas 104 from a nutrient solution production/storage area 110, including, but not limited to, carbon dioxide, phosphate, water, and other elements that may help the azolla growth. One of ordinary skill in the art would appreciate that there are numerous elements, and types of systems that could be used to deliver these elements to the biomass growing areas, and embodiments of the present invention are contemplated for use with any such systems.

In certain embodiments, artificial light (not shown), such as artificial LED lighting, may be used to increase growth in the growing areas 104. One of ordinary skill in the art would appreciate that there are numerous types of artificial lights that could be used, and embodiments of the present invention are contemplated for use with any form of artificial lighting.

In certain embodiments, a CO₂ concentration system 108 may be utilized to provide carbon dioxide to the growing area. In certain embodiments, that may include a pressure-swing and/or temperature-swing absorption system which concentrates CO₂ from ambient outside air and is then pumped or otherwise delivered to the growing area. One of ordinary skill in the art would appreciate that there are numerous ways to provide and concentrated CO₂ for deployment to the azolla growing area, and embodiments of the present invention are contemplated for use with any such methods/systems.

According to an embodiment of the present invention, the power source (not shown) may be any form of providing appropriate electrical current to the system to run the various powered components. In preferred embodiments of the present invention, these may be renewable sources, such as solar arrays, wind turbines, geothermal, hydroelectric, or any combination thereof. However, other embodiments may use non-renewable sources, such as natural gas, nuclear or other sources.

In certain embodiments, a cooling system 112 may be utilized to keep the growing area at appropriate temperatures. For instance, a radiator cooling system may be utilized, taking advantage of ambient temperatures, particularly at night, when temperatures drop. Other cooling systems could include dry cooling systems, fin-fan cooler systems, heat pumps or other forms of heating/cooling systems. One of ordinary skill in the art would appreciate that there are numerous types of cooling or heating systems that could be utilized with embodiments of the present invention, depending on the location of the grow house, and the need to alter ambient temperatures, and embodiments of the present invention are contemplated for use with any appropriate heating or cooling systems.

In a preferred embodiment, treatment area 134 of the PFAS remediation system 100 comprises one or more of a harvested biomass outlet 114, a treated water outlet line 116, a hydrodynamic cavitation treatment area 118, a separator 120, granular activated carbon (GAC) filters 122, various water lines (124, 126, 128, 130), and a treated biomass outlet 132. The treatment area 134 may be located inside of the grow house 102 or set apart from the grow house 102.

In an example configuration, the PFAS remediation system 100 has grow house 102 with a first end that is connected to a water source that delivers PFAS contaminated water 106 to the PFAS remediation system 100. The PFAS contaminated water 106 enters the grow house 102 and is conveyed to a growing areas 104 that includes an array of stacked hydroponic tray that contain a PFAS absorbing biomass. As shown in the enlarged portion of FIG. 1, each hydroponic tray 138 can support a layer of PFAS absorbing biomass, such as Azolla. The growth of the PFAS absorbing biomass can be promoted by various systems including, but not limited to, artificial lighting, nutrient supplementation (via nutrient solution production/storage area 110), and enriched CO₂ levels (via the CO₂ concentration system 108). The CO₂ and nutrients can be pumped into the water and air of the hydroponic trays 138 and growing areas 104.

In the example configuration, the PFAS contaminated water 106 flows through the hydroponic trays 138 where the PFAS in the PFAS contaminated water 106 can be absorbed and filtered by PFAS absorbing biomass (e.g. Azolla). Eventually, treated water exits the growing area 104 and array of hydroponic trays 138 at a treated water outlet line 116 at a second end of the grow house 102. The treated water is filtered through a granular activated carbon (GAC) filter 122 to remove residual PFAS in the treated water and to provide a “polished” water. The “polished water” may be returned to the array via a polished water return line 126 or discharged from the system via an outlet line 130.

In the example configuration, PFAS containing biomass, which is harvested from hydroponic trays 138 after absorbing PFAS, can be discharged through a harvested biomass outlet 114 at a second end of the grow house 102. The harvested PFAS containing biomass is subjected to hydrodynamic cavitation treatment in the hydrodynamic cavitation treatment area 118 to break down the absorbed PFAS. As the PFAS are broken down, fluorine 136 may be produced and captured by the system. The treated biomass resulting from the hydrodynamic cavitation treatment can be moved to a separator 120 where the residual water remaining on the treated biomass can be removed. The residual water can exit the separator 120 and be returned to the array via a residual water return line 128. The residual water can also exit the separator 120 via a residual water outlet line 124 to be filtered through a granular activated carbon (GAC) filter 122 to remove residual PFAS in the residual water and to provide a “polished” water. The “polished water” may be returned to the array via a polished water return line 126 or discharged from the system via an outlet line 130. The treated and dried treated biomass can be removed from the system via the treated biomass outlet 132.

According to an embodiment of the present invention, a processing plant may be utilized to process PFAS containing biomass that has filtered and retained a sufficient amount of PFAS or other unwanted elements. In a preferred embodiment, the processing plant may take the PFAS containing biomass, dry it, and convert it into a separate usable material (e.g., biofertilizer, livestock feed). Further, in certain embodiments, the processing plant may be further configured to dewater and recapture water and other essential elements from the biomass before processing, and return the resources to the grow house or other portion of the system. In some embodiments, the entire movement of the portion of the grow house holding the PFAS absorbing biomass (e.g., hydroponic trays) may be automated to move along an assembly style line, with younger and less saturated PFAS absorbing biomass (i.e. Azolla plants) at the beginning (i.e. first end) of the grow house. The hydroponic trays would be moved toward the second end of the grow house as the PFAS absorbing biomass becomes more contaminated or saturated. Once reaching the second end of the grow house, the hydroponic trays can be conveyed to the processing plant portion, at which point the tray or other holding element, would be cleaned, and sent to the beginning of the growhouse to begin the process again. One of ordinary skill in the art would appreciate that this could be configured in numerous ways, and embodiments of the present invention are contemplated for use with any appropriate configuration.

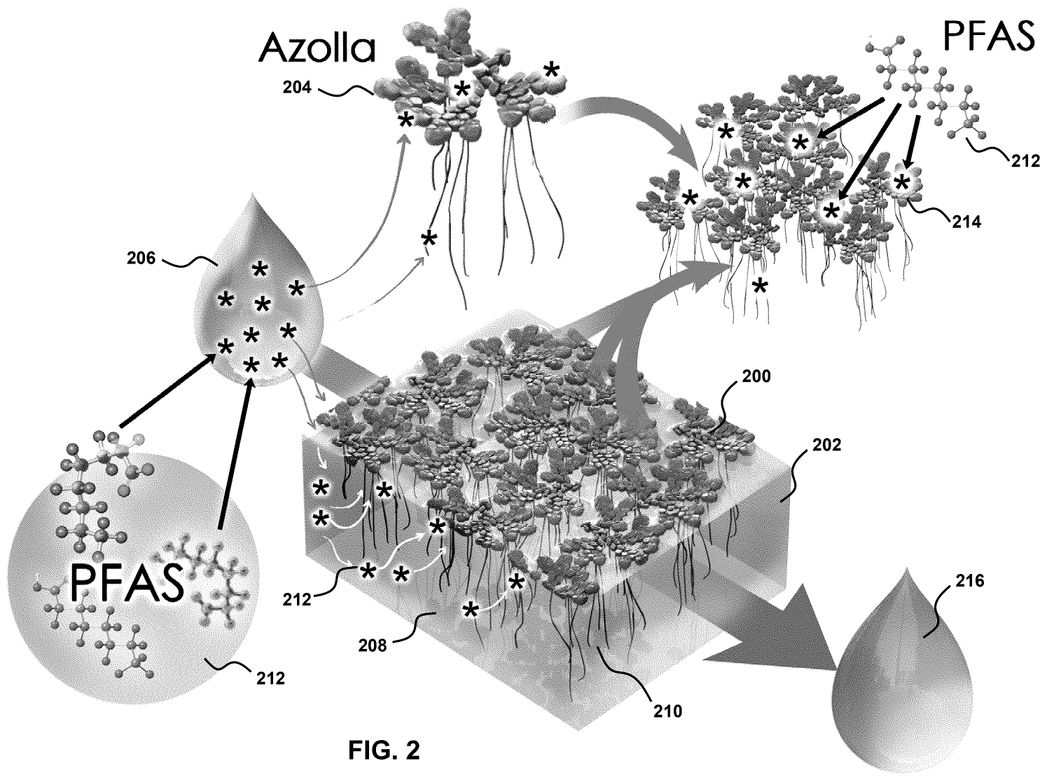

Turning now to FIG. 2, an illustration of an aquatic plant filtering PFAS from water. In a preferred embodiment, a PFAS absorbing biomass 200 is placed into water 202. In some embodiments, the PFAS absorbing biomass 200 may be an aquatic plant from the genus Azolla 204. As PFAS contaminated water 206 is introduced to a treatment area 208, the PFAS contaminated water 206 flows around parts of the PFAS absorbing biomass 200, including the roots 210 of the PFAS absorbing biomass 200, and PFAS 212 are filtered and absorbed by the PFAS absorbing biomass 200. With the PFAS 212 being absorbed by the now PFAS containing biomass 214, treated water 216 can be discharged from the treatment area 208.

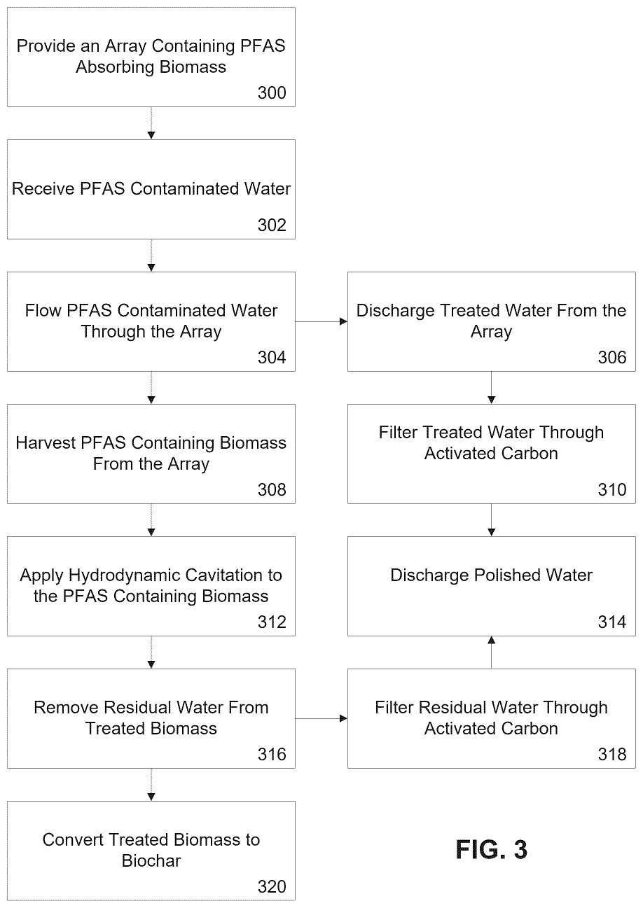

Turning now to FIG. 3, a process flow diagram of an exemplary method of removing PFAS from water, in accordance with an embodiment of the present invention. At 300, an array of hydroponic trays containing a biomass capable of absorbing PFAS is provided. The array may be supplied with carbon dioxide (CO₂) to promote the growth the PFAS absorbing biomass. At 302, the array receives PFAS contaminated water from a source including, but not limited to, ground water, surface water, industrial water supply, municipal water supply, or any other water source. At 304, the PFAS contaminated water flows through the array. As the PFAS contaminated water flows through the array, the PFAS absorbing biomass (e.g. Azolla) absorbs and filters PFAS from the PFAS contaminated water resulting in treated water and PFAS containing biomass. At 306, the treated water is discharged from the array for further treatment. At 308, PFAS containing biomass is harvested from the array for further treatment. At 310, the treated water is filtered through activated carbon to remove residual PFAS in the treated water and to provide a “polished” water. At 312, the harvested PFAS containing biomass is subjected to a hydrodynamic cavitation treatment. The hydrodynamic cavitation treatment creates microbubbles that collapse and release energy, in the form of heat, that can break down PFAS molecules from the PFAS containing biomass. Additionally, the hydrodynamic cavitation treatment generates fluorine that may be collected. The result of the hydrodynamic cavitation treatment is a treated biomass. At 316, the treated biomass is moved to a separator to remove residual water from the treated biomass. At 318, the residual water collected from the treated biomass may be filtered through activated carbon to remove residual PFAS in the residual water and to provide a “polished” water. Alternatively, the residual water may be returned to the array without further filtering. At 314, polished water may be returned to the array or discharged from the system. At 320, the treated biomass may be converted to biochar for use as granular activated carbon (GAC).

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A system for remediating polyfluorinated substances (PFAS) from water comprising:
an array of one or more trays that contain a biomass capable of absorbing PFAS from PFAS contaminated water, wherein the array has a first end that receives the PFAS contaminated water and a second end that discharges treated water;
a hydrodynamic cavitation treatment area that receives PFAS containing biomass, wherein the PFAS containing biomass is treated with hydrodynamic cavitation causing a breakdown of PFAS on the PFAS containing biomass;
a separator that removes residual water from treated biomass; and
one or more activated carbon filter modules that receive one or both of the treated water from the second end of the array and the residual water from the separator, wherein the activated carbon filter modules remove residual PFAS from the treated water and the residual water and discharge polished water.

2. The system of claim 1, wherein the biomass is as aquatic plant of the genus Azolla.

3. The system of claim 1, further comprising a carbon dioxide concentration system supplying carbon dioxide to the array.

4. The system of claim 1, further comprising a cooling system to maintain an optimal temperature for growth of the biomass.

5. The system of claim 1, wherein the hydrodynamic cavitation treatment area is connected to the second end of the array to receive PFAS containing biomass.

6. The system of claim 1, wherein the hydrodynamic cavitation treatment area includes an agitator to induce the hydrodynamic cavitation.

7. The system of claim 1, wherein the separator is a centrifuge or a drainage basket.

8. The system of claim 1, wherein the separator is connected to the hydrodynamic cavitation treatment area to receive the treated biomass.

9. The system of claim 1, wherein the separator is connected to the array to return residual water to the array upstream of the second end of the array.

10. The system of claim 1, wherein the activated carbon modules have an inlet connected to one or both of the second end of the array and the separator.

11. The system of claim 1, wherein the activated carbon modules have an outlet connected to one or both of the array and a system outlet.

12. A method for remediating polyfluorinated substances (PFAS) from water comprising:
providing an array containing a PFAS absorbing biomass;
receiving PFAS contaminated water from a water source;
flowing the PFAS contaminated water through the array;
discharging treated water from the array;
harvesting PFAS containing biomass from the array;
applying hydrodynamic cavitation to the PFAS containing biomass to produce treated biomass, wherein the hydrodynamic cavitation causes a breakdown of PFAS on the PFAS containing biomass; and
filtering the treated water through activated carbon to remove residual PFAS and produce polished water.

13. The method of claim 12, further comprising supplying carbon dioxide to the PFAS absorbing biomass.

14. The method of claim 12, further comprising collecting fluorine generated during the breakdown of the PFAS.

15. The method of claim 12, further comprising discharging polished water to the array.

16. The method of claim 12, further comprising discharging polished water to a system outlet.

17. The method of claim 12, further comprising removing residual water from the treated biomass.

18. The method of claim 17, further comprising filtering the residual water through activated carbon to remove residual PFAS and produce polished water.

19. The method of claim 17, further comprising discharging residual water to the array.

20. The method of claim 17, further comprising producing activated carbon material by converting treated biomass to biochar.
